(19) United States
(12) Patent Application Publication
(10) Pub. No.: US 2012/0180476 A1
(43) Pub. Date: Jul. 19, 2012

(54) INTERNAL COMBUSTION ENGINE WITH EXHAUST-GAS TURBOCHARGING

(75) Inventors: Bernd Steiner, Bergisch Gladbach (DE); Kai Sebastian Kuhlbach, Bergisch Gladbach (DE); Rainer Friedfeldt, Huerth (DE)

(73) Assignee: FORD GLOBAL TECHNOLOGIES, LLC, Dearborn, MI (US)

(21) Appl. No.: 13/351,968

(22) Filed: Jan. 17, 2012

(30) Foreign Application Priority Data
Jan. 17, 2011 (DE) 102011002759.9

(51) Int. Cl. F02B 37/18; F01P 1/06

(52) U.S. Cl. 60/602; 123/41.31

(57) ABSTRACT

The present disclosure relates to a supercharged internal combustion engine having at least one liquid-cooled cylinder head with at least two cylinders, each cylinder having at least one exhaust gas outlet opening with an exhaust line attached to each outlet. The exhaust lines from each outlet merge to form an integrated exhaust manifold within the cylinder head and an overall exhaust line directing exhaust gas outside of the cylinder head, and the at least one liquid-cooled turbine having a turbine housing arranged in said overall exhaust line. Further, a bypass line, separate from the exhaust lines forming the integrated exhaust manifold, branches off upstream of the turbine conducting blown-off exhaust gas past the turbine and outside of the turbine housing.

### RELATED APPLICATIONS

The present application claims priority to German Patent Application No. 102011002759.9, filed on Jan. 17, 2011, the entire contents of which are hereby incorporated by reference for all purposes.

### FIELD

The present disclosure relates to a supercharged internal combustion engine having at least one liquid-cooled cylinder head, turbine and exhaust system including a bypass line for the extraction of exhaust gas that branches off upstream of the turbine and via which bypass line the extracted exhaust gas can be conducted past the turbine.

### BACKGROUND AND SUMMARY

Within the context of the present disclosure, the expression “internal combustion engine” encompasses diesel engines, spark-ignition engines and also hybrid internal combustion engines.

Internal combustion engines feature exhaust systems that include a combined exhaust gas line forming an exhaust manifold downstream of cylinders of the engines. Downstream of the exhaust manifold, the exhaust gases are generally supplied to at least one turbine of an exhaust-gas turbocharger, and if appropriate to one or more exhaust-gas aftertreatment systems. The turbine may be arranged as close as possible to outlet openings of the cylinders in order thereby to be able to optimally utilize the exhaust-gas enthalpy of the hot exhaust gases and to ensure a fast response behavior of the turbocharger. The path of the hot exhaust gases to the different exhaust-gas aftertreatment systems may also be as short as possible such that the exhaust gases are given little time to cool down and the exhaust-gas aftertreatment systems reach their operating temperature or light-off temperature as quickly as possible, in particular after a cold start of the internal combustion engine. Therefore, according to the present disclosure, the at least one exhaust manifold is integrated entirely in the cylinder head, as a result of which the overall length and the volume of the exhaust lines upstream of the turbine are minimized A cylinder head of said type is also characterized by a very compact design which permits dense packaging of the overall drive unit. The use of such a cylinder head also leads to a reduced number of components, and consequently to a reduction in costs, in particular assembly and procurement costs.

A further aspect of the present disclosure comprises a small design of the turbine cross section and simultaneous provision of an exhaust-gas blow-off facility. This wastegate configuration counteracts the drop in charge pressure that may be experienced when supercharging an internal combustion engine with an exhaust-gas turbocharger. If the exhaust-gas mass flow exceeds a critical value, a control element opens the bypass line and a part of the exhaust-gas flow is conducted past the turbine via the bypass line during the course of the so-called exhaust-gas blow-off. This allows a smaller turbine, designed for small to medium exhaust-gas quantities, to handle larger exhaust-gas quantities, for instance, those experienced at high load or high rotational speed, by conducting at least a portion of the gas past the turbine.

In some arrangements, the bypass line is at least partially integrated in the turbine housing. For example, European patent application EP 2 143 922 A1 describes a supercharged internal combustion engine in which the housing of the turbine also encompasses the bypass line and/or the control element. However, this construction increases the volume and weight of the turbine housing, leading to increased production and material cost.

Therefore, it is an object of the present disclosure to provide a supercharged internal combustion engine comprising at least one liquid-cooled cylinder head with at least two cylinders, each cylinder having at least one exhaust gas outlet opening; an exhaust line attached to each outlet, the exhaust lines from each outlet merging to form an integrated exhaust manifold within the cylinder head and an overall exhaust line directing exhaust gas outside of the cylinder head; at least one liquid-cooled turbine having a turbine housing arranged in said overall exhaust line; and a bypass line, forming a separate exhaust line, branching off upstream of the turbine conducting blown-off exhaust gas past the turbine and outside of the turbine housing.

Said arrangement of the turbine makes it possible for even large-volume exhaust-gas aftertreatment systems to be positioned in a close-coupled arrangement to the side of the cylinder block and downstream of the turbine, while simultaneously realizing dense packaging.

The present disclosure will be described in more detail below with reference to the following figures, which are drawn approximately to scale.

### BRIEF DESCRIPTION OF THE DRAWINGS

FIG. 1 schematically shows the cylinder head and the turbine of an exhaust-gas turbocharger of a first embodiment of the supercharged internal combustion engine in a perspective illustration,

FIG. 2 shows the arrangement of cylinder head and turbine illustrated in FIG. 1, in a plan view of the assembly end side of the cylinder head and

FIG. 3 shows, in a perspective illustration, the arrangement of cylinder head and turbine illustrated in FIG. 1, sectioned perpendicularly to the assembly end side.

FIG. 4 shows an exemplary method of cooling the internal combustion engine of FIGS. 1-3.

### DETAILED DESCRIPTION

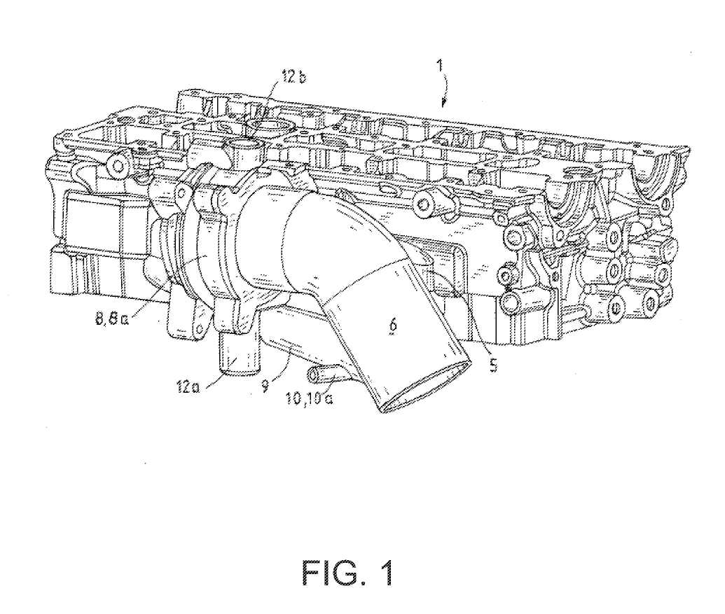

FIG. 1 schematically shows the cylinder head 1 and the turbine 8 of an exhaust-gas turbocharger of a first embodiment of the supercharged internal combustion engine in a perspective illustration.

The turbine 8 is liquid-cooled and is arranged in the overall exhaust line 6 via which the exhaust gases collected by the exhaust manifold 5 are discharged out of the cylinder head 1. The turbine is located within a turbine housing 8a is equipped with coolant ducts to form the liquid cooling arrangement, wherein the coolant is supplied via a coolant inlet opening 12a and is discharged via a coolant outlet opening 12b. Turbine housing 8a may be attached directly to cylinder head 1, and a cooling arrangement of cylinder head 1 may provide coolant from the cylinder head 1 to coolant inlet opening 12a of turbine housing 8a. The cylinder head 1 may have an internal manifold 5 coupling exhaust ports 4a, 4b of a plurality of cylinders 2 and a coolant passage. In this way, cylinder head 1 may include a cooled integrated exhaust manifold 5 that is cooled via the coolant passing through the coolant passages. Turbine housing 8a may be coupled to the cylinder head 1 downstream of internal manifold 5 and have a coolant passage fluidically coupled to the coolant passage of the cylinder head 1 so that coolant may flow from cylinder head 1 to turbine housing 8a. Further, it is possible for the liquid cooling arrangement of the turbine 8 to be equipped with a separate heat exchanger or else—in the case of a liquid-cooled internal combustion engine—for the heat exchanger of the engine cooling arrangement, that is to say the heat exchanger of a different liquid cooling arrangement, to be used for this purpose. The latter merely requires corresponding connections between the two circuits.

A compressor (not shown) and turbine 8 may be arranged on the same shaft, with the hot exhaust-gas flow being supplied to the turbine 8 and expanding in turbine 8 with a release of energy, as a result of which the shaft is set in rotation. The energy supplied by the exhaust-gas flow to the turbine 8 and ultimately to the shaft is used for driving the compressor which is likewise arranged on the shaft. The compressor delivers and compresses the charge air supplied to it, as a result of which supercharging of the cylinders 2 is obtained.

During assembly, the shaft of the exhaust-gas turbocharger may be inserted, as a separate prefabricated assembly together with the pre-mounted turbine and compressor rotors, for example in the form of a cassette, into the turbine housing 8a or turbocharger housing which is integrated into the cylinder head 1. Here, the housing 8a may hold not only turbine components 8 but rather also parts of the compressor. It is further possible to attach fresh air lines to and from the compressor, for example the line from the compressor outlet to the inlet side of the cylinder head 1. Furthermore, it is possible for a fresh air line to be integrated into a cylinder head cover, and for the distance to the compressor housing to be bridged by a duct, wherein said duct may for example also be part of the cylinder head 1.

The turbine 8 may be designed as a radial turbine, that is to say the flow approaching the rotor blades runs substantially radially. Here, “substantially radially” means that the speed component in the radial direction is greater than the axial speed component. The speed vector of the flow intersects the shaft or axle of the turbine 8, specifically at right angles if the approaching flow runs exactly radially. To make it possible for the rotor blades to be approached by flow radially, the inlet region for the supply of the exhaust gas is often designed as an encircling spiral or worm housing, such that the inflow of exhaust gas to the turbine 8 runs substantially radially. The turbine 8 may however also be designed as an axial turbine, in which the speed component in the axial direction is greater than the speed component in the radial direction.

The turbine 8 may be equipped with a variable turbine geometry, which enables a more precise adaptation to the respective operating point of an internal combustion engine of an adjustment of the turbine geometry or of the effective turbine cross section. Here, adjustable guide blades for influencing the flow direction are arranged in the inlet region of the turbine 8. In contrast to the rotor blades of the rotating rotor, the guide blades do not rotate with the shaft of the turbine 8.

If the turbine 8 has a fixed, invariable geometry, the guide blades are arranged in the inlet region so as to be not only stationary but rather also completely immovable, that is to say rigidly fixed. In contrast, in the case of a variable geometry, the guide blades are duly also arranged so as to be stationary but not so as to be completely immovable, rather so as to be rotatable about their axes, such that the flow approaching the rotor blades can be influenced.

It is also possible to use a plurality of turbochargers whose turbines 8 and compressors are arranged in series or parallel.

For the blow-off of exhaust gas, that is to say for bypassing the turbine 8, a bypass line 9 is provided which branches off upstream of the turbine 8 and via which exhaust gas can be conducted past the turbine 8. Bypass line 9 may be a pipe piece produced from heat-resistant steel and may be screwed to the cylinder head, whereas at an opening-in point into the overall exhaust line, a welded connection may also be provided instead of a screw connection. Bypass line 9 may be coupled to the cylinder head 1 downstream of exhaust manifold 5 and in parallel with turbine housing 8a. Here, the bypass line 9, as a separate exhaust line, may lead past the turbine 8 outside the turbine housing 8a and opens into the overall exhaust line 6 again downstream of the turbine 8, in which overall exhaust line an exhaust-gas aftertreatment system (not illustrated) is arranged downstream of the opening-in point of the bypass line 9. Bypass line 9 may branch off of overall exhaust line 6, exhaust manifold 5, in particular in the region in which the exhaust lines open into a common overall exhaust line and the hot exhaust gas of the cylinders of the internal combustion engine is collected, or any other location upstream of turbine 8. Bypass line 9 may rejoin the overall exhaust line 6 at any point downstream of the turbine 8, including upstream or downstream of an aftertreatment system, the latter of which may result in the two gas flows being supplied separately to the aftertreatment system.

To adjust the blown-off exhaust-gas flow, a control element 10 is provided which, in the embodiment illustrated in FIG. 1, is arranged at that end of the bypass line 9 at which the bypass line 9 enters into the overall exhaust line 6. The control element may alternately be arranged directly at the branch of the bypass line, that is to say in the vicinity of the pick-off point, in order to allow for cooling of the control element by the liquid cooling arrangement provided in the cylinder head, or may be otherwise advantageously attached to the bypass line. At the control element 10, a pivotable flap 10a whose rotary axle projects out of the bypass line 9 controls the bypass line 9 to be closed off or opened up. The flap 10a may open the bypass line 9 when the load of the turbocharger exceeds a predetermined threshold, or when an exhaust gas temperature exceeds a predetermined threshold. The control element 10 may alternately or additionally comprise a valve and may be electrically, hydraulically, pneumatically, mechanically, or magnetically controlled by, for instance, an engine controller of the internal combustion engine.

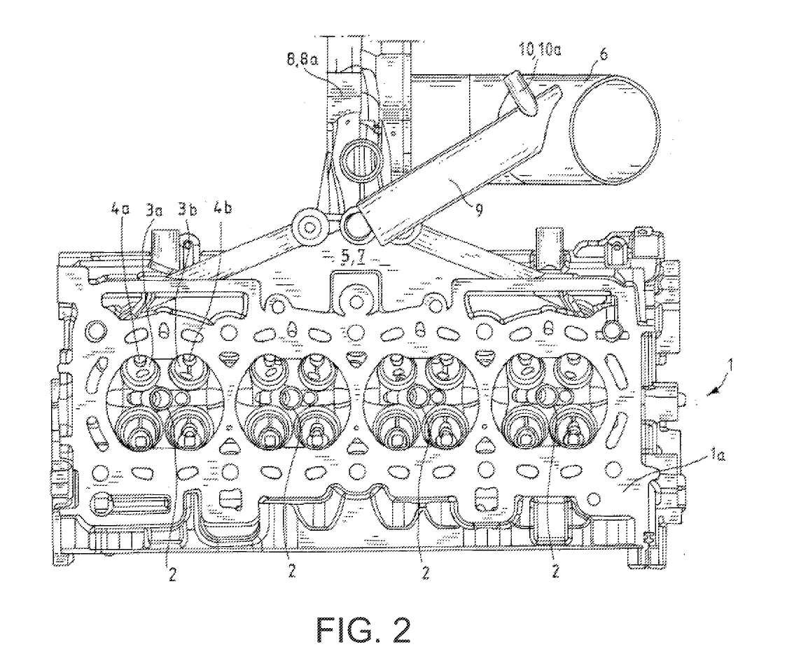

FIG. 2 shows the arrangement of cylinder head 1 and turbine 8 illustrated in FIG. 1, in a plan view of the assembly end side 1a of the cylinder head 1. The cylinder head 1 can be connected at the assembly end side 1a to a cylinder block (not illustrated) in order to form cylinders 2. It is sought merely to explain the additional features in relation to the above-described FIG. 1, for which reason reference is made otherwise to FIG. 1. The same reference signs are used for the same components.

As can be seen from FIG. 2, the illustrated cylinder head 1 has four cylinders 2 in an in-line arrangement along the longitudinal axis of the cylinder head 1. Here, the cylinder head 1 shown is that of a four-cylinder in-line engine.

Each cylinder 2 has two outlet openings 3a, 3b for discharging the exhaust gases, wherein each outlet opening 3a, 3b is adjoined, downstream, by an exhaust line 4a, 4b. The exhaust lines 4a, 4b of the four cylinders 2 merge, to form the overall exhaust gas line 6, within the cylinder head 1 so as to form an integrated exhaust manifold 5.

The at least one cylinder head 1 may have three or more cylinders 2 and only the exhaust lines 4a, 4b of two cylinders 2 merge, to form an overall exhaust line 6, within the cylinder head 1. In the case of three or more cylinders 2, embodiments are also advantageous in which at least three cylinders 2 are configured in such a way as to form two groups with in each case at least one cylinder 2, and the exhaust lines 4a, 4b of the cylinders 2 of each cylinder group merge in each case into an overall exhaust line 6 so as to form an exhaust manifold 5. Cylinder head 1 may have four cylinders in an in-line arrangement, in which the exhaust lines 4a, 4b of the outer cylinders 2 and the exhaust lines 4a, 4b of the inner cylinders 2 are merged in each case to form one overall exhaust line 6.

The bypass line 9 may branch off on the side facing toward the assembly end side 1a, that is to say on that side of the manifold 5 which faces toward the cylinder block, specifically at the collecting point 7 of the exhaust gases in the head 1, at which the individual exhaust lines 4a, 4b of the exhaust manifold 5 merge to form the overall exhaust line 6. Bypass line 9 may be connected at an input side of the bypass line 9 to the overall exhaust gas line 6 upstream of the turbine housing 8a, and connected at an output side of the bypass line 9 to a location downstream of the turbine housing 8a. In this way, the bypass line 9 is situated externally from the turbine housing, forming a separate exhaust line from the merged exhaust lines 4a, 4b that form the exhaust manifold 5, and directs exhaust flow outside of the turbine housing 8a.

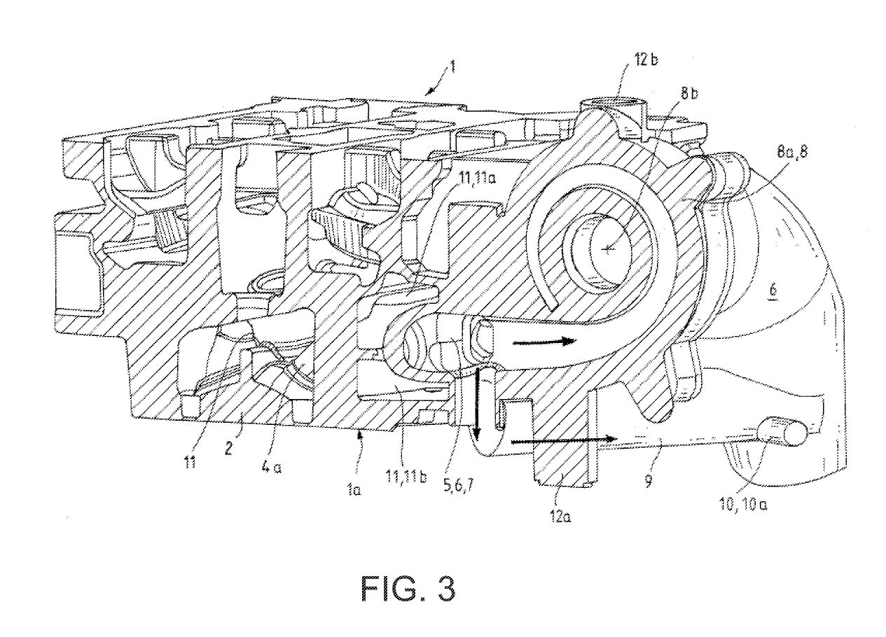

FIG. 3 shows, in a perspective illustration, the arrangement of cylinder head 1 and turbine 8 illustrated in FIGS. 1 and 2—sectioned perpendicularly to the assembly end side 1a.

It is sought merely to explain the additional features in relation to the above-described FIGS. 1 and 2, for which reason reference is made otherwise to said figures. The same reference signs are used for the same components.

The cylinder head 1, with an integrated manifold 5 is thermally more highly loaded than a cylinder head which is equipped with an external manifold, and therefore places greater demands on the cooling arrangement. To keep the thermal loading of the cylinder head within a desired range, a part of the heat flow introduced into the cylinder head 1 may be extracted from the cylinder head 1 again. In general, cooling of the cylinder head 1 is effected in a targeted manner by forced convection. To this end, cylinder head 1 is equipped with a liquid cooling arrangement, wherein to form the liquid cooling arrangement, coolant jackets 11, 11a, 11b are provided. The liquid cooling arrangement comprises inter alia a lower coolant jacket 11b, which is arranged between the integrated exhaust manifold 5 and the assembly end side 1a, and an upper coolant jacket 11a, which is arranged on the opposite side of the exhaust manifold 5 from the lower coolant jacket 11b. Coolant jackets 11, 11a, 11b thereby form an arrangement of coolant ducts that conduct the coolant through the cylinder head 1. Here, the coolant is fed by a pump (not shown) arranged in the cooling circuit, such that said coolant circulates in the coolant jacket. The heat dissipated to the coolant is discharged from the interior of the cylinder head 1 in this way, and is extracted from the coolant again in a heat exchanger (not shown).

It is fundamentally possible for the cooling arrangement to take the form of either an air cooling arrangement or a liquid cooling arrangement. As significantly greater amounts of heat can be dissipated by liquid cooling, a cylinder head 1 of the present type is generally formed with a liquid cooling arrangement.

In the cylinder head 1, at least one connection is arranged on that side of the integrated exhaust manifold 5 which faces away from the at least two cylinders 2 of the cylinder head 1. The at least one connection is therefore situated outside the integrated exhaust manifold 5. The spacing between the at least one connection and the overall exhaust line 6 may be smaller than the diameter of a cylinder 2, for instance smaller than half or one quarter of the diameter of a cylinder 2, with the spacing being the distance between the wall of the overall exhaust line 6 and the wall of the at least one connection. The cooling action may be improved by virtue of a pressure gradient being generated between the upper and lower coolant jackets 11, 11a, 11b, as a result of which the speed in the at least one connection is increased, which leads to an increased heat transfer as a result of convection. Such a pressure gradient also offers advantages if the lower coolant jacket 11b and the upper coolant jacket 11a are connected to the coolant duct of the turbine 8. The pressure gradient then serves as a driving force for conveying the coolant through the coolant duct of the turbine 8.

In the view illustrated in FIG. 3, it can be seen that the rotor of the turbine 8 is arranged above the assembly end side 1a, and may be positioned above the integrated exhaust manifold 5, that is to say on that side of the integrated exhaust manifold 5 which faces away from the assembly end side 1a. The axis of rotation 8b of the rotor, that is to say the turbine shaft on which the rotor is rotatably mounted, is situated above the assembly end side 1a.

The turbine housing 8a of the turbine 8 and the cylinder head 1 may be formed in one piece, that is to say the housing 8a and the cylinder head 1 form a monolithic component, which in the present case is a cast part. The exhaust-gas flow through the turbine 8 or through the bypass line 9 is denoted by arrows. The turbine housing 8a and the at least one cylinder head 1 may alternatively be separate components which are connected to one another in a non-positively locking, positively locking and/or cohesive fashion.

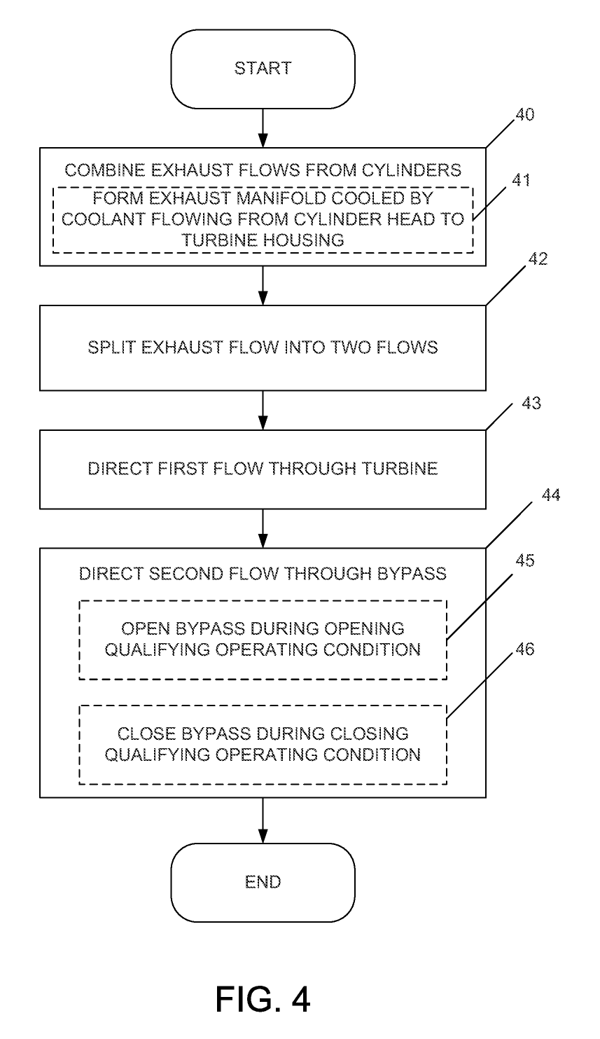

FIG. 4 shows an exemplary method of cooling the internal combustion engine shown in the preceding FIGS. 1-3. As shown in step 40, exhaust flows from each of a plurality of cylinders 2 coupled to cylinder head 1 are combined. This forms an exhaust manifold 5 integrated into the cylinder head 1, which may be cooled by coolant flowing from cylinder head 1 to turbine housing 8a, at step 41. The combined flow is then split at step 42 into a separated first flow and second flow. Both steps 41 and 42 may occur within cylinder head 1. At step 43, the first flow is directed from the cylinder head 1 to the turbine housing 8a to flow through turbine 8, turbine 8 and turbine housing 8a being attached to the cylinder head 1, so that it may be cooled by coolant flowing from coolant inlet 12a to coolant outlet 12b of turbine housing 8a, and further so that it may drive the turbine 8. At step 44, the second flow is directed from the cylinder head 1 to and through a bypass line 9 which passes downstream of, and outside, the turbine 8 and turbine housing 8a. In this way, the second flow does not contact the turbine 8 or flow within the turbine housing 8a, reducing heat transfer to the turbine 8. As shown in step 45, bypass line 9 may be opened during an opening qualifying operating condition, for instance when the turbocharger load exceeds a predetermined threshold or the exhaust gas temperature exceeds a predetermined threshold. In this case, the exhaust gas may flow through the bypass line and exit the cylinder head without entering the turbine housing, as the exhaust gas may be directed through the bypass line to a combined exhaust line downstream of the turbine. As shown in step 46, bypass line 9 may be closed during a closing qualifying operating condition, for instance, when the turbocharger is operating at normal loads and temperatures.

Note that the cylinder head 1 may have a respective outlet for each of the first and second flows, the first outlet coupling with the turbine housing 8a, and the second outlet coupling with the bypass line 9. While the bypass line inlet is coupled directly to the cylinder head 1 in this case, it may alternatively be coupled to a line coupling the turbocharger inlet with the cylinder head 1. Further, note that the exhaust manifold 5 contained within the cylinder head 1 may first combine flows from two or more cylinders 2 and then divide the flow, still within the cylinder head 1. Each of the manifold 5, manifold inlet flows (from each respective cylinder 2), combined flow, and split first and second flows may be adjacent to internal coolant passages of the cylinder head 1.

1. An internal combustion engine comprising:
at least one liquid-cooled cylinder head with at least two cylinders, each cylinder having at least one exhaust gas outlet opening;
an exhaust line attached to each outlet, the exhaust lines from each outlet opening merging to form an integrated exhaust manifold within the cylinder head and an overall exhaust line directing exhaust gas outside of the cylinder head;
at least one liquid-cooled turbine having a turbine housing arranged in said overall exhaust line; and
a bypass line, forming a separate exhaust line from the merged exhaust lines that form the exhaust manifold, branching off upstream of the turbine conducting blown-off exhaust gas past the turbine and outside of the turbine housing.

2. The internal combustion engine as claimed in claim 1, wherein the bypass line branches off from the overall exhaust line.

3. The internal combustion engine as claimed in claim 1, wherein the bypass line branches off from the integrated exhaust manifold.

4. The internal combustion engine of claim 1, wherein each cylinder has at least two outlet openings, and the exhaust lines of at least two cylinders merge, to form an overall exhaust line, within the cylinder head such that an integrated exhaust manifold is formed, with firstly the exhaust lines of the at least two outlet openings of each cylinder merging to form a partial exhaust line associated with the cylinder, before said partial exhaust lines merge to form the overall exhaust line.

5. The internal combustion engine of claim 1, wherein the bypass line opens into the overall exhaust line downstream of the turbine.

6. The internal combustion engine of claim 5, wherein an exhaust-gas aftertreatment system is arranged downstream of the bypass line and downstream of the turbine.

7. The internal combustion engine of claim 1, wherein the at least one cylinder head is connected, at an assembly end side, to a cylinder block, and the bypass line branches off on the side facing toward the assembly end side.

8. The internal combustion engine of claim 1, wherein the at least one cylinder head can be connected, at an assembly end side, to a cylinder block, wherein the rotor of the at least one turbine is arranged above, on that side of the assembly end side which faces toward the cylinder head.

9. The internal combustion engine of claim 1, wherein the bypass line is equipped with a control element for adjusting the blown-off exhaust gas flow.

10. The internal combustion engine of claim 1, wherein the housing of the at least one turbine and the at least one cylinder head are separate components which are connected to one another in a non-positively locking, positively locking and/or cohesive fashion.

11. The internal combustion engine of claim 1, wherein at least a part of the turbine housing of the at least one turbine and the at least one cylinder head are formed in one piece and form a monolithic component.

12. The internal combustion engine of claim 11, wherein the monolithic component is a cast part.

13. The internal combustion engine of claim 12, wherein the monolithic component is an aluminum cast part.

14. The internal combustion engine of claim 1, wherein the bypass line comprises a pipe piece produced from heat-resistant steel.

15. The internal combustion engine of claim 9, wherein the bypass line comprises a housing for the control element, which housing is produced preferably from gray cast iron or cast steel.

16. A method of cooling an engine, comprising:
within a cylinder head, combining exhaust flows from a plurality of cylinders, and then splitting the combined exhaust flow into a first flow and a second flow;
directing the first flow from the cylinder head to a turbine housing attached to the cylinder head; and
directing the second flow from the cylinder head to a bypass and downstream of, and outside, the turbine housing.

17. The method of claim 16, further comprising flowing coolant from the cylinder head to the turbine housing.

18. The method of claim 17, wherein the cylinder head includes a cooled exhaust manifold via the coolant.

19. The method of claim 16, wherein the exhaust gas flow is directed through the bypass to a combined exhaust line downstream of the turbine housing.

20. An engine comprising:
a cylinder head, having an internal manifold coupling exhaust ports of a plurality of cylinders and a coolant passage;
a turbine housing coupled to the cylinder head downstream of the internal manifold having a coolant passage fluidically coupled to the coolant passage of the cylinder head; and
a bypass, having a control valve therein, coupled to the cylinder head downstream of the manifold and in parallel with the turbine housing.
